(19) United States
(12) Patent Application Publication
(10) Pub. No.: US 2013/0290574 A1
(43) Pub. Date: Oct. 31, 2013

(54) KEYBOARD AND ELECTRONIC DEVICE USING THE SAME

(71) Applicants: YUN-JING WANG, Shenzhen City (CN); CAI-JIN YUAN, Shenzhen City (CN)

(72) Inventors: YUN-JING WANG, Shenzhen City (CN); CAI-JIN YUAN, Shenzhen City (CN)

(21) Appl. No.: 13/660,006

(22) Filed: Oct. 25, 2012

(30) Foreign Application Priority Data
Apr. 28, 2012 (CN) 201210129047.9

(51) Int. Cl. G06F 13/14

(52) U.S. Cl. 710/67

(57) ABSTRACT

A keyboard for an electronic device includes a main body, a connection state indicator positioned on an outside surface of the main body, and a keyboard port. Both the main body and the connection state indicator are electrically connected to a network host of an electronic device through the keyboard port. The electronic device can be operated using the keyboard and the connection state indicator indicates a connection state between the network host and a local area network.

### BACKGROUND

1. Technical Field

The present disclosure relates to keyboards for electronic devices, and particularly to a keyboard and an electronic device using the same.

2. Description of the Related Art

Electronic devices, such as personal computers (PCs) or servers usually have a connection state indicator to monitor and inform a connection state of a network. The connection state indicator is usually electrically connected to a RJ-45 port of the electronic device. However, in assembly of the electronic device, the RJ-45 port and the connection state indicator are together assembled at a back of the electronic device, which is difficult to view and monitor the connection state between the electronic device and the network.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of an electronic device, according to an exemplary embodiment.

FIG. 2 is a schematic view of a keyboard of the electronic device shown in FIG. 1.

FIG. 3 is a circuit diagram showing an electric connection between the keyboard shown in FIGS. 1-2 and a network host of the electronic device shown in FIG. 1.

### DETAILED DESCRIPTION

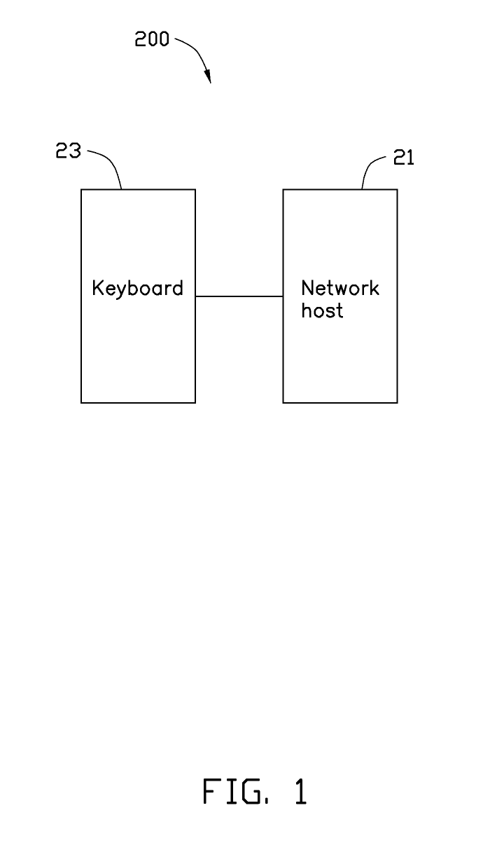

FIG. 1 shows an electronic device 200, according to an exemplary embodiment. The electronic device 200 can be a personal computer (PC) and includes a network host 21 and a keyboard 23 that can be electronically connected to the network host 21.

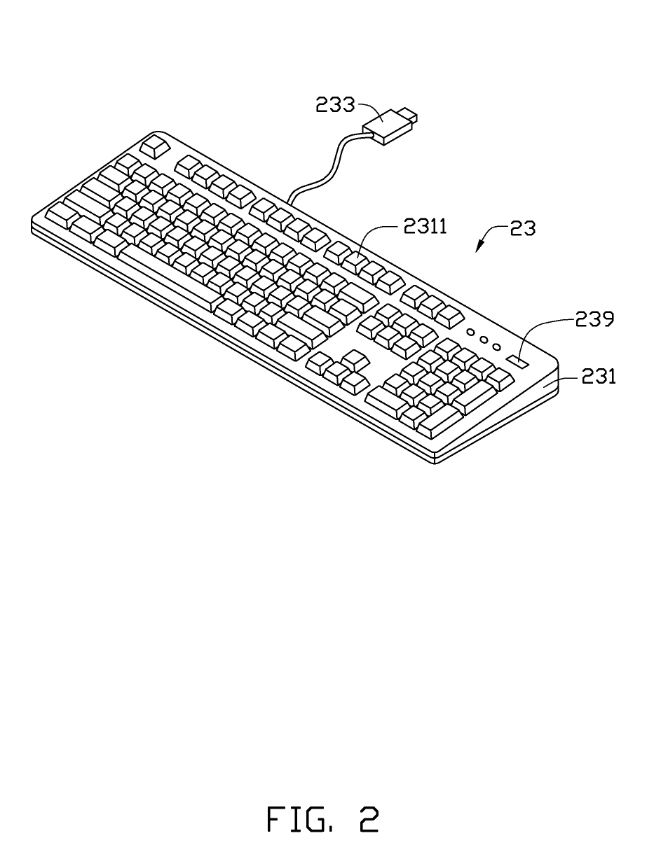

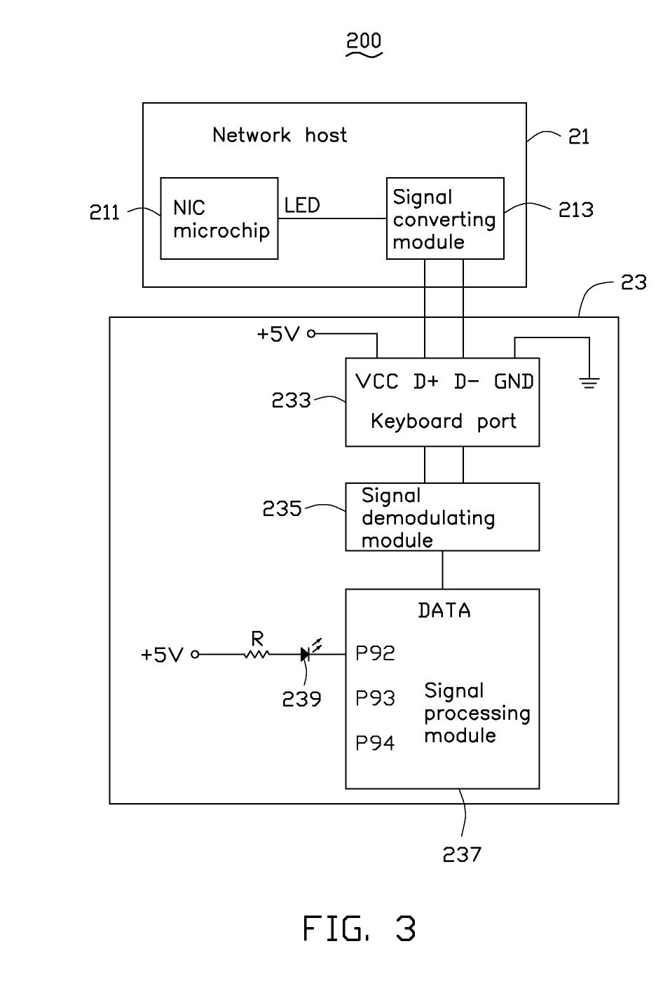

Also referring to FIGS. 2 and 3, the keyboard 23 includes a main body 231, a keyboard port 233, a signal demodulating module 235, a signal processing module 237 and a connection state indicator 239. The main body 231 can be a typical keyboard and includes a plurality of keys 2311 for operating the electronic device 200. The connection state indicator 239 may be a light emitting diode and is positioned on an outside surface of the main body 231. Both the main body 231 and the connection state indicator 239 can be electronically connected to the network host 21 through the keyboard port 233, such that the network host 21 can be operated by manipulation of the main body 231 and the connection state indicator 239 can indicate a connection state between the network host 21 and an external local area network (LAN). The manipulation of the main body 231 may include key presses, for example.

The network host 21 is designed to receive a motherboard and other components (not shown) of the electronic device 200, such as memory, connectors, hard drives, and power supplies. In this embodiment, the network host 21 includes a network interface card (NIC) microchip 211 and a signal converting module 213. The NIC microchip 211 is designed to allow and carry out communication and data transmission between the network host 21 and the LAN. The NIC microchip 211 can be a network adapter. In this embodiment, the NIC microchip 211 includes a connection state pin LED. The NIC microchip 211 outputs a corresponding command signal through the connection state pin LED to indicate a connection state between the NIC microchip 211 and the LAN. For example, when the NIC microchip 211 outputs a first command signal (e.g., logic 1) through the connection state pin LED, which indicates that a connection between the NIC microchip 211 and the LAN is not established. When the NIC microchip 211 outputs a second command signal (e.g., logic 0) through the connection state pin LED, which indicates that a connection between the NIC microchip 211 and the LAN is established.

The signal converting module 213 is electrically connected to the NIC microchip 211. The signal converting module 213 processes the command signal output by the connection state pin LED and converts the command signal into a control signal which can be received by the keyboard port 233. In detail, the signal converting module 213 converts a first voltage (e.g., about 3 volts) from the connection state pin LED into a second voltage (e.g., about 5 volts) and provides the second voltage to the keyboard port 233. The signal converting module 213 further converts the analog command signal from the connection state pin LED into a digital control signal and outputs the digital control signal to the keyboard port 233.

The keyboard port 233 can be a Universal Serial Bus (USB) interface and includes a power pin VCC, a first data pin D+, a second data pin D−, and a grounding pin GND. The power pin VCC is connected to a +5V power source. The first and second data pins D+, D− are both connected to the signal converting module 213 and receive the command signal from the connection state pin LED through the signal converting module 213 (i.e. the control signal). The grounding pin GND is connected to ground.

In this embodiment, the signal demodulating module 235 can be a demodulator and is electronically connected to the first and second data pins D+, D−. Due to the keyboard port 233 needing to receive both a typical USB bus signal and the control signal from the signal converting module 213, thus the signal demodulating module 235 processes the two signals received by the keyboard port 233 (i.e., USB bus signal and the control signal) to demodulate and divide the control signal from the USB bus signal and only output the demodulated control signal to the signal processing module 237.

The signal processing module 237 is positioned inside of the main body 231 and can be an EM78448A/B Single-Chip Microcomputer (SCM). The signal processing module 237 includes a data receiving pin DATA and a plurality of idle pins P92-P94. The data receiving pin DATA is connected to the signal demodulating module 235 and receives the demodulated control signal from the signal demodulating module 235. One of the idle pins P92-P94 (e.g., idle pin P92) is connected to a cathode of the connection state indicator 239. The other idle pins (e.g., idle pins P93-P94) are floating. An anode of the connection state indicator 239 is connected to the +5V power source through a resistor R.

When the data receiving pin DATA of the signal processing module 237 receives the control signal from the signal demodulating module 235, the signal processing module 237 outputs a drive signal according to the control signal to the idle pin P92, thereby indicating a connection state between the NIC microchip 211 and the LAN. For example, when the data receiving pin DATA of the signal processing module 237 obtains a first control signal corresponding to the first command signal, the signal processing module 237 outputs a first driving signal (e.g., logic 1) through the idle pin P92. In this way, the connection state indicator 239 turns off to indicate that a connection between the NIC microchip 211 and the LAN is not established.

When the data receiving pin DATA of the signal processing module 237 obtains a second control signal corresponding to the second command signal, the signal processing module 237 outputs a second driving signal (e.g., logic 0) through the idle pin P92. In this way, the connection state indicator 239 turns on (e.g., lights) to indicate that a connection between the NIC microchip 211 and the LAN is established.

In use, the keyboard port 233 of the keyboard 23 is electrically connected to the network host 21. In this way, the first and second data pins D+, D− are both connected to the signal converting module 213 and receive the command signal from the connection state pin LED through the signal converting module 213. Then, when the NIC microchip 211 has not established a connection with the LAN, the NIC microchip 211 outputs a first command signal through the connection state pin LED. The first command signal is received by the signal converting module 213 and is converted into a first control signal. The keyboard port 233 receives the first control signal and a USB bus signal and sends the two signals to the signal demodulating module 235. The signal demodulating module 235 receives the two signals and demodulates the first control signal from the two signals. The signal processing module 237 receives and processes the first control signal and outputs a first driving signal through the idle pin P92. Thus, the connection state indicator 239 turns off to indicate a connection between the NIC microchip 211 and the LAN is not established.

Similarly, when the NIC microchip 211 establishes a connection with the LAN, the NIC microchip 211 outputs a second command signal through the connection state pin LED. The second command signal is received by the signal converting module 213 and is converted into a second control signal. The keyboard port 233 receives the second control signal and the USB bus signal, and sends the two signals to the signal demodulating module 235. The signal demodulating module 235 receives the two signals and demodulates the second control signal from the two signals. The signal processing module 237 receives and processes the second control signal and outputs a second driving signal through the idle pin P92. Thus, the connection state indicator 239 turns on to indicate a connection between the NIC microchip 211 and the LAN is established.

In summary, in the keyboard and the electronic device of this embodiment of the disclosure, the connection state indicator 239 is positioned on outside surface of the keyboard 23, therefore, the NIC microchip 211 can output different command signals to control and change the connection state indicator 239. Thus, users can easily view, inform and monitor a connection state between the network host 21 and the LAN by identifying the connection state indicator 239.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. A keyboard for an electronic device, comprising:
a main body;
a connection state indicator positioned on an outside surface of the main body; and
a keyboard port; wherein both the main body and the connection state indicator are electronically connected to a network host of the electronic device through the keyboard port, such that manipulation of the main body operates the electronic device and the connection state indicator indicates a connection state between the network host and an external local area network (LAN).

2. The keyboard as claimed in claim 1, wherein the connection state indicator is a light emitting diode.

3. The keyboard as claimed in claim 1, further comprising a signal processing module connected to the connection state indicator, wherein the network host comprises a network interface card (NIC) microchip, the network host outputs a command signal through the NIC microchip, the signal processing module receives the command signal and outputs a driving signal corresponding to the command signal, the connection state indicator is turned on/off under control of the driving signal to indicate the connection state between the NIC microchip and the LAN.

4. The keyboard as claimed in claim 3, further comprising a signal demodulating module connected to the keyboard port and the signal processing module, wherein the signal demodulating processes the command signal and a Universal Serial Bus (USB) signal received by the keyboard port and demodulates the command signal from the USB signal.

5. The keyboard as claimed in claim 4, wherein the signal demodulating module is a demodulator.

6. The keyboard as claimed in claim 4, wherein the signal processing module comprises a data receiving pin and a plurality of idle pins, the data receiving pin is connected to the signal demodulating module, one of the idle pins is connected to a cathode of the connection state indicator, an anode of the connection state indicator is connected to a power supply, other idle pins are floating.

7. The keyboard as claimed in claim 3, wherein when the connection state between the NIC microchip and the LAN is not established, the NIC microchip outputs a first command signal, the signal processing module receives the first command signal and outputs a corresponding first driving signal, the connection state indicator is turned off under control of the first driving signal.

8. The keyboard as claimed in claim 3, wherein when the connection between the NIC microchip and the LAN is established, the NIC microchip outputs a second command signal, the signal processing module receives the second command signal and outputs a corresponding second driving signal, the connection state indicator is turned on under control of the second driving signal.

9. An electronic device, comprising:
a network host; and
a keyboard electrically connected to the network host, the keyboard comprising:
a main body;
a connection state indicator; and
a keyboard port; wherein both the main body and the connection state indicator are electrically connected to the network host through the keyboard port, such that manipulations of the main body operates the electronic device, and the connection state indicator indicates a connection state between the network host and an external local area network (LAN).

10. The electronic device as claimed in claim 9, wherein the connection state indicator is a light emitting diode.

11. The electronic device as claimed in claim 9, further comprising a signal processing module connected to the connection state indicator, wherein the network host comprises a network interface card (NIC) microchip, the network host outputs a command signal through the NIC microchip, the signal processing module receives the command signal and outputs a driving signal corresponding to the command signal, the connection state indicator is turned on/off under control of the driving signal to indicate the connection state between the NIC microchip and the LAN.

12. The electronic device as claimed in claim 11, further comprising a signal demodulating module connected to the keyboard port and the signal processing module, wherein the signal demodulating processes the command signal and a Universal Serial Bus (USB) signal received by the keyboard port and demodulates the command signal from the USB signal.

13. The electronic device as claimed in claim 12, wherein the signal demodulating module is a demodulator.

14. The electronic device as claimed in claim 12, wherein the signal processing module comprises a data receiving pin and a plurality of idle pins, the data receiving pin is connected to the signal demodulating module, one of the idle pins is connected to a cathode of the connection state indicator, an anode of the connection state indicator is connected to a power supply, other idle pins are floating.

15. The electronic device as claimed in claim 11, wherein when the connection between the NIC microchip and the LAN is not established, the NIC microchip outputs a first command signal, the signal processing module receives the first command signal and outputs a corresponding first driving signal, the connection state indicator is turned off under control of the first driving signal.

16. The electronic device as claimed in claim 11, wherein when the connection between the NIC microchip and the LAN is established, the NIC microchip outputs a second command signal, the signal processing module receives the second command signal and outputs a corresponding second driving signal, the connection state indicator is turned on under control of the second driving signal.

17. The electronic device as claimed in claim 11, wherein the network host comprises a signal converting module connected to the NIC microchip, the signal converting module processes the command signal output by the NIC microchip and converts the command signal into a control signal received by the keyboard port.

18. The electronic device as claimed in claim 17, wherein the NIC microchip comprises a connection state pin outputting the command signal, the signal converting module converts a first voltage from the connection state pin into a second voltage and provides the second voltage to the keyboard port.

19. The electronic device as claimed in claim 18, wherein the signal converting module further converts the analog command signal from the connection state pin into a digital control signal and outputs the digital control signal to the keyboard port.
